(19) United States
(12) Patent Application Publication
(10) Pub. No.: US 2008/0115335 A1
(43) Pub. Date: May 22, 2008

(54) Hook Device for a Strap Assembly

(76) Inventor: Gary Jeffrey McCay, Queensland (AU)

Correspondence Address: YOUNG & THOMPSON, 209 Madison Street, Suite 500, ALEXANDRIA, VA, 22314, US

(21) Appl. No.: 11/666,641

(22) PCT Filed: Oct. 28, 2005
(86) PCT No.: PCT/AU05/01669

§ 371 Date: Sep. 27, 2007

(30) Foreign Application Priority Data
Oct. 29, 2004 (AU) 2004906210

(51) Int. Cl. F16G 11/00

(52) U.S. Cl. 24/131 R

(57) ABSTRACT

A hook device (10) is provided for connecting an end of a strap assembly (40). The device comprises a base portion (12) arranged to extend in one plane and a bent portion (14) arranged to extend in the same one plane. The base portion is arranged for connection to one end of a strap or cord (42) of the strap assembly and has an opening (18) configured to allow another hook device (10) to pass therethrough. The bent portion (14) is arranged to hook onto an object. The base portion and said bent portion can be formed of a single wire or plate material. The opening in the base portion can also be configured to receive a finger of a user.

### TECHNICAL FIELD OF THE INVENTION

THIS INVENTION relates to a hook device for a strap assembly.

### BACKGROUND OF THE INVENTION

Strap assemblies are generally used to hold down loads. For example, the assemblies can be used to hold down loads on a vehicle bed. Each assembly has a strap or cord section and attachment devices at ends thereof. One form of the attachment devices is a hook.

The inventor created a strap assembly with a hook device as shown in FIG. 1. This hook is complex and therefore costly to manufacture. This hook has a base portion and a bent portion which are in different planes. It therefore occupies a relatively large volume in packaging and thereby has a relatively higher transportation costs per unit volume.

The hook, if pulled with a hand, may slip out and cause injury to a user or a person nearby. This hook has a relatively larger surface area and is more likely to cause injury should the strap recoil.

### OBJECT OF THE PRESENT INVENTION

An object of the present invention is to alleviate or to reduce to a certain level one or more of the above prior art disadvantages.

### OUTLINE OF THE PRESENT INVENTION

In one aspect therefore the present invention resides in a hook device for a strap assembly. The device comprises a body having a base portion extending in one plane and a hook portion extending in said one plane. The base portion is arranged for connection to an end of a strap member of the strap assembly and has an opening configured to allow another hook device connected to opposite end of the strap member to pass therethrough. The bent portion is arranged for hooking onto an object. The hook portion has a neck part extending outwardly from the base portion, and a first end part spaced from the neck part and extending inwardly towards the base portion and terminating at a tip to define a mouth through which said object enters the hook portion. The first end part is configured so that said tip does not protrude from the base portion.

Preferably, said body is formed of a single wire or plate material. More preferably, said body is formed of a stamping of the plate material.

The opening in the base portion may also be configured to receive a finger of a user.

The hook portion may have a neck part extending outwardly from the base portion, and a first end part spaced from the neck part and extending inwardly towards the base portion to define a mouth. The first end part may have a free end formed as the tip. Preferably said tip is arranged to border said mouth. Said tip may be shaped in the form of a curved part.

The base portion may be configured as a loop around said opening. The base portion may have a second end part extending to close said loop. The second end part is preferably fixed to the hook portion.

In another aspect therefore, the present invention resides in a strap assembly comprising a strap or cord with opposed ends and a hook device as aforementioned at each end thereof.

Preferably, the strap or cord is elastic.

### BRIEF DESCRIPTION OF THE DRAWINGS

In order that the present invention can be more readily understood and be put into practical effect reference will now be made to the accompanying drawings which illustrate non-limiting embodiments of the present invention and wherein:—

FIG. 1 is a perspective view of a prior art strap assembly;

FIG. 2 is a perspective view from above of a schematic diagram illustrating an embodiment of the hook device according to the present invention;

FIG. 3 shows a perspective view from below of the hook device shown in FIG. 2;

FIG. 4 shows a side view of an embodiment of the hook device with a different wire bending configuration from the device shown in FIG. 2; and

FIG. 5 shows a strap assembly having a hook device being used to anchor around a pole.

### DETAILED DESCRIPTION OF THE INVENTION

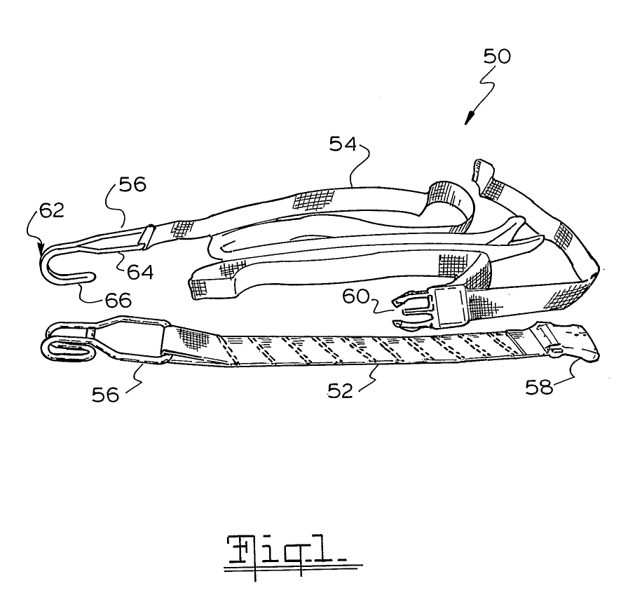

Referring to FIG. 1, the strap assembly 50 as shown has a strap 52 formed of an elastic cord embedded in webbing and another strap 54 formed of an inextensible webbing material. Each of the straps 52 and 54 have a hook device 56 at one end thereof and compatible coupling devise 58,60 at opposite end thereof.

In use, the coupling device 60 is coupled to the device 58 as is known in the art, and the effective length of the strap 54 is adjusted by positioning the device 60 therealong.

The hook device 56 has an end tip part 62 that extends in a plane substantially perpendicular to the plane containing the base portion 64, and an end portion 66 that is in a plane spaced from the plane of the base portion 64.

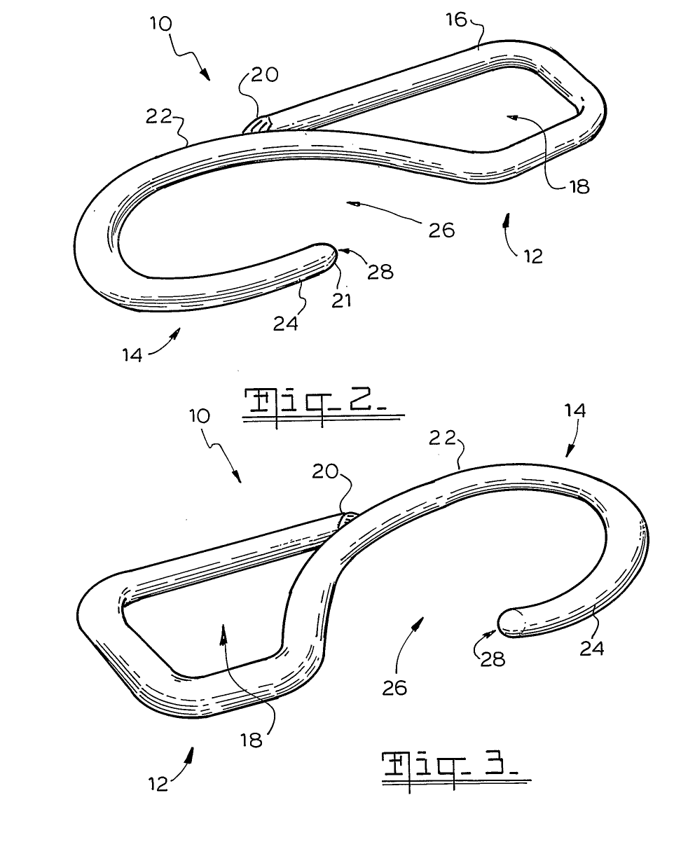

Referring now the embodiment of the hook device 10 shown in FIGS. 2 to 4. The device 10 has a base portion 12 and a bent portion 14 extending from and in a substantially same plane as the base portion 12. The device 10 is formed by appropriately bending a single piece of wire having opposed ends 20 and 21.

In the embodiment shown in FIGS. 2 and 3, the base portion 12 forms a closed loop 16 around an opening 18. The free end part 20 of the base portion 12 is fixed to the bent part 14.

The bent portion 14 has a neck part 22 extending outwardly from the base portion 12, and an end part 24 spaced from the neck part 22 and extending inwardly towards the base portion 12. The end part 24 terminates short of the base portion 12 to form a mouth 26 therewith. The end 21 is shaped to form a curved end tip part 28 which represents the extremity of the bent portion 14.

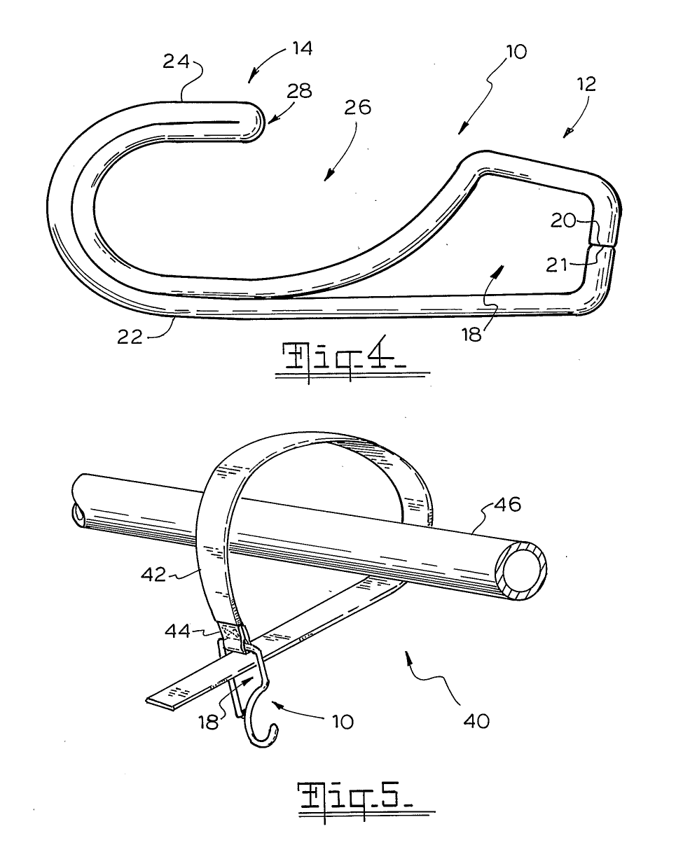

In the embodiment shown in FIG. 4, the wire is bent so that its opposed ends 20 and 21 meet at the base portion 12 and are arranged to close the opening 18. The curved end tip part 28 is formed by turning the wire onto itself.

In both the embodiment shown in FIGS. 2 and 3, and the embodiment shown in FIG. 4, the base portion 12 is configured so that another device 10 can pass through the opening 18. The opening 18 is also configured to allow a user to place a finger therein when pulling a strap or cord attached to the device 10.

The hook device 10 as shown is formed by bending a piece of wire into shape. This can be accomplished by a simply forming process. Accordingly, the manufacturing costs are relatively lower, and less material is required. As the device 10 is substantially flat (both portions 12 and 14 in the same plane), relatively more of the devices 10 can be packaged per unit volume. Thus, the transportation costs are lower than prior art. Furthermore, as the base portion 12 and the bent portion 14 are in the same plane, and the tip part 28 extends towards the base portion 12, there is less likelihood of the tip part causing injury to the user or others nearby.

Turning to FIG. 5, there is shown an embodiment of a strap assembly 40 having a strap 42 with opposed ends 44 to each of which is attached the device 10 (one end only shown). The devices 10 are attached to the ends 44 by means of webbing, fabric, leather or any suitable material extending through the opening 18 and fixed to respective ends 44.

The opening 18 is configured to allow the device 10 which is attached to the opposite end 44 to pass therethrough as shown. As such, the device 10 allows the assembly 40 to be fixed about an anchoring such as a pole 46. The hook 10 can also hook onto the cord part or strap 42 of the strap assembly 40 without the cord part having to twist 90 degrees. The twisted strap 42 would tend to untwist itself, resulting in the hook 10 coming off the strap 42.

The opening 18 of the device 10 as shown is particularly advantageous as it allows a user to place a finger therein without interfering with the bent hook portion 14. With the finger in the opening 18, the base portion 12 prevents the accidental slipping of the hand from the hook 10. This overcomes the problems of the prior art assembly 50 shown in FIG. 1 where a finger in the base portion 64 would block passage into the mouth of the bent hook portion, and the finger would also jam on the anchoring.

Whilst the above has been given by way of illustrative example of the present invention many variations and modifications thereto will be apparent to those skilled in the art without departing from the broad ambit and scope of the invention as herein set forth in the following claims.

1-15. (canceled)

16. A hook device for a strap assembly, the device comprises a body having a base portion extending in one plane and a hook portion extending in said one plane, the base portion being arranged for connection to an end of a strap member of the strap assembly and having an opening configured to allow another hook device connected to the opposite end of the strap member to pass therethrough, and the hook portion being arranged for hooking onto an object, wherein said hook portion having a neck part extending outwardly from the base portion, and a first end part spaced from the neck part and extending inwardly towards the base portion and terminating at a tip to define a mouth through which said object enters the hook portion, the first end part being configured so that said tip does not protrude from the base portion.

17. The device according to claim 16 wherein the opening in the base portion is configured to receive a finger of a user.

18. The device according to claim 16 wherein the base portion is configured as a loop around said opening.

19. The device according to claim 16 wherein the base portion has a second end part extending to close said loop.

20. The device according to claim 19 wherein the second end part is fixed to the hook portion.

21. The device according to claim 18 wherein said body is formed of a single wire or plate material.

22. The device according to claim 21 wherein said body is formed of a stamping of the plate material.

23. The device according to claim 21 wherein said wire having opposed ends arranged to meet at said base portion.

24. The device according to claim 21 wherein said wire having opposed ends, one of said ends being arranged in said base portion and the other end being arranged as the tip in said hook portion.

25. The device according to claim 16 wherein said first end part has a free end arranged as the tip to border said mouth and the tip is shaped in the form of a curved part.

26. The device according to claim 16 wherein said base portion is configured as a loop around said opening and the base portion has a second end part extending to close said loop.

27. The device according to claim 26 wherein said second end part is fixed to the hook portion.

28. A strap assembly comprising a strap or cord with opposed strap/cord ends and a hook device as claimed in claim 16 connected at each strap end.

29. The assembly according to claim 28 wherein the strap or cord is formed of an elastic material.

30. The assembly according to claim 28 wherein the strap or cord is formed of at least two sections joined by adjustable coupling means arranged to be selectively positionable for adjusting length of the strap or cord.

31. The device according to claim 17 wherein the base portion is configured as a loop around said opening.

32. The device according to claim 17 wherein the base portion has a second end part extending to close said loop.

33. The device according to claim 19 wherein said body is formed of a single wire or plate material.

34. The device according to claim 20 wherein said body is formed of a single wire or plate material.

35. The assembly according to claim 29 wherein the strap or cord is formed of at least two sections joined by adjustable coupling means arranged to be selectively positionable for adjusting length of the strap or cord.
